(19) United States
(12) Patent Application Publication
(10) Pub. No.: US 2006/0102197 A1
(43) Pub. Date: May 18, 2006

(54) Post-etch treatment to remove residues

(76) Inventors: Kang-Lie Chiang, San Jose, CA (US); Man-Ping Cai, Saratoga, CA (US); Shawming Ma, Sunnyvale, CA (US); Yan Ye, Saratoga, CA (US); Peter Hsieh, San Jose, CA (US)

Correspondence Address: MOSER IP LAW GROUP / APPLIED MATERIALS, INC., 1040 BROAD STREET, 2ND FLOOR, SHREWSBURY, NJ, 07702, US

(21) Appl. No.: 10/989,678

(22) Filed: Nov. 16, 2004

(51) Int. Cl. B08B 6/00; B08B 5/04

(52) U.S. Cl. 134/1.2; 134/1.1; 134/21

(57) ABSTRACT

A method for removing residue from a layer of conductive material on a substrate is provided herein. In one embodiment, the method includes introducing a process gas into a vacuum chamber having a substrate surface with residue from exposure to a fluorine-containing environment. The process gas includes a hydrogen-containing gas. Optionally, the process gas may further include an oxygen-containing or a nitrogen containing gas. A plasma of the process gas is thereafter maintained in the vacuum chamber for a predetermined period of time to remove the residue from the surface. The temperature of the substrate is maintained at a temperature between about 10 degrees Celsius and about 90 degrees Celsius during the plasma step.

### BACKGROUND OF THE INVENTION

1. Field of the Invention

The present invention relates to semiconductor processing technologies and, more particularly, to treating post-etch material surfaces to remove residues.

2. Description of the Related Art

The performance, density, and cost of integrated circuit (IC) chips have been improving at a dramatic rate. Much of the improvement has been due to the ability to scale transistors to increasingly smaller dimensions, resulting in higher speed and higher functional density. The continued shrinking of transistor sizes on the IC chips, however, poses many challenges to backend interconnects. As the minimum feature size on the IC's shrinks below 0.18 μm, the metal interconnect lines become thinner and more densely packed, resulting in greater resistance in the metal lines and larger intermetal capacitance, and therefore a longer time delay or slower operating speed. By changing to different materials, such as higher conductivity material for the metal lines and lower permittivity (low-k) dielectric for the insulating material, smaller device geometry may be realized without significantly impacting the maximum operating speed. This prompted the switch from aluminum and silicon dioxide to copper and low-k dielectrics for the backend interconnect for manufacturing many sub-0.18 μm IC devices.

Copper has been chosen as the interconnection material for ultra-large-scale integrated circuits (ULSI) because it offers both higher conductivity and better electromigration resistance over aluminum. To prevent copper movement into intermetal dielectrics, barrier layers are often used between the copper lines and the intermetal dielectrics. Examples of the materials used for the barrier layers include conductive barriers, such as Ta or Ta-based alloys, Ti or TiN, and TiW, and dielectric barriers, such as silicon nitride, silicon carbide, silicon oxycarbide, and the like. These barriers not only prevent copper from diffusing into the intermetal dielectrics, they also provide adhesion between copper and the intermetal dielectrics.

In addition to the use of the barrier layers, the switch from aluminum/oxide to copper/low-k also involves a variety of fundamental changes in the backend manufacturing process flow. Since it is difficult to etch copper, new approaches such as “damascene” or “dual damascene” processing are required. Copper damascene/dual-damascene is a process where vias and/or trenches are etched in the insulating material. Copper is then filled into the vias and/or trenches and planarized using a process such as chemical mechanical polishing (CMP) such that conducting materials are only left in the vias and trenches. In the dual damascene approach, as shown in FIGS. 1A and 1B, both vias 112 and trenches 110 are patterned into a dielectric stack 100 over a layer of copper lines 120 (or other conductor, such as a gate electrode) before the copper fill step. The dielectric stack 100 includes a stack of dielectric and barrier materials, such as the dielectric material 101 over the barrier material 103. An advantage of the dual damascene approach is that only one copper fill and CMP process is necessary to form an upper layer of metal lines 130 and vias 132 that connect the upper layer of metal lines 130 to the conductive layer of copper lines 120 under the dielectric stack 100, as shown in FIG. 1B.

The patterning of the dielectric stack in the dual damascene approach can be performed in different processing sequences. Some pattern the vias first and some the trenches first. Whichever processing sequence is used, to form the dual damascene structures, the dielectric stack 100 is etched to the copper lines 120 underlying the dielectric stack 100. As a result, an upper surface 121 of the copper lines is exposed to a dielectric etching environment, especially near the end of etching the barrier materials 103 at the bottom of the dielectric stack. This also happens in some single damascene processes. As a result of such exposure, residues can be formed on the upper surface 121 of the copper lines 120 as well as on the etched sidewalls of the dielectric stack 100. FIG. 2 shows an illustrative depiction of the upper surface 121 of the copper lines 120 exposed after etching the dielectric layer 103 above the upper surface 121. As shown in FIG. 2, residues 202 have formed on the upper surface 121 of the copper lines 120 and on the sidewalls of the dielectric stack 100. The residues 202, if not removed quickly after the dielectric etching, can cause further corrosion of the copper lines when the copper surface is exposed to moisture in the atmosphere. Current methods of removing the residues 202 involve the use of wet chemical solutions, which are costly and time-consuming.

Therefore, there is a need for a faster and less expensive method of removing the residues left on the copper surface after inter-metal dielectric etching in a dual damascene process.

### SUMMARY OF THE INVENTION

A method for removing residue from a substrate is provided herein. In one embodiment, the method includes introducing a process gas into a vacuum chamber having a substrate surface with residue from exposure to a fluorine-containing environment. The process gas includes a hydrogen-containing gas. Optionally, the process gas may further include an oxygen-containing or a nitrogen containing gas. A plasma of the process gas is formed and maintained in the vacuum chamber for a predetermined period of time to remove the residue from the surface. The temperature of the substrate is maintained at a temperature between about 10 and about 90 degrees Celsius during the plasma step.

In another embodiment, a method of opening a dielectric barrier layer above a layer of copper lines on a semiconductor substrate during a damascene or dual damascene process is provided. The method includes introducing a fluorine-containing process gas into a vacuum chamber in which the substrate is located then maintaining a plasma of the fluorine-containing process gas in the vacuum chamber to etch the dielectric barrier layer, thereby uncovering surface of the layer of copper lines. A process gas including a hydrogen-containing gas is then introduced into the vacuum chamber. Optionally, the process gas may further include an oxygen-containing or a nitrogen containing gas. A plasma of the process gas is maintained in the vacuum chamber to remove residue formed on the surface of the layer of copper lines from exposure to the fluorine-containing process gas. The temperature of the substrate is maintained at a temperature between about 10 and about 90 degrees Celsius during the plasma step.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

FIGS. 1A and 1B are schematic views in vertical cross-section of conventional dual damascene structures;

FIG. 2 is an illustrative depiction showing residues on a copper surface at a bottom of a via after conventional dielectric barrier etching;

FIG. 3A-3D are schematic cross-sectional views of evolving structures on a semiconductor substrate in a damascene process flow;

FIG. 4 is a flowchart illustrating a plasma treatment after a damascene process flow;

FIG. 5A-5G are schematic cross-sectional views of evolving structures on a semiconductor substrate in a dual damascene process flow;

FIG. 6 is a flowchart illustrating a plasma treatment after a dual damascene process flow;

FIG. 7 is a flowchart illustrating a plasma treatment process for removing residues on copper surface; and

FIG. 8 is a schematic cross-sectional view of a plasma reactor that can be used to practice the plasma treatment process for removing residues on copper surface.

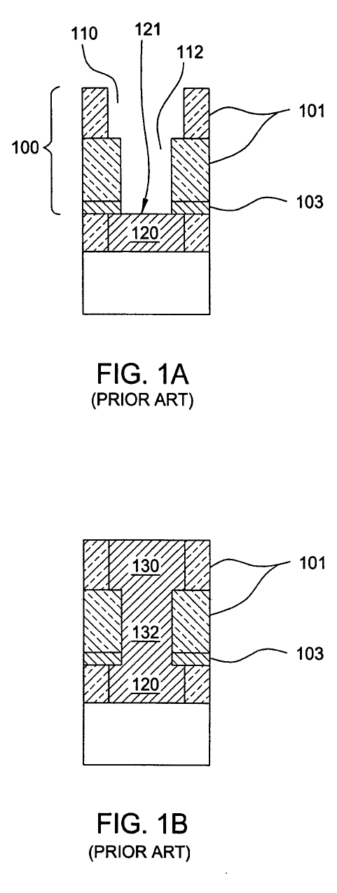

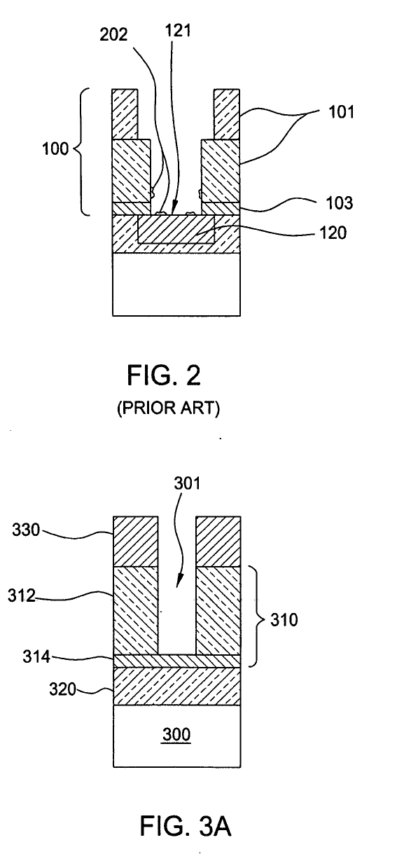

To facilitate understanding, identical reference numerals have been used, where possible, to designate identical elements that are common to the figures.

### DETAILED DESCRIPTION

The present invention includes a method for treating an exposed upper surface of a layer of conductive material on a substrate to remove residues on the exposed surface, as well as any residues formed on the sidewalls proximate the exposed surface, e.g. the sidewalls of a contact via. In one embodiment, the method is performed in a plasma reactor having a vacuum chamber in which the substrate is placed. A process gas is introduced to the chamber. The process gas includes a hydrogen-containing gas and, optionally, an oxygen-containing or a nitrogen-containing gas. A plasma of the process gas is maintained in the vacuum chamber for a period of time to allow the residues to react with species in the plasma and be removed from the surface. During the plasma treatment process, the temperature of the substrate is maintained between about 10 and about 90 degrees Celsius.

The method is also useful for treating a surface of conductive materials as part of a damascene or dual damascene process, and is performed after a dielectric barrier etching process in the damascene or dual damascene process. In one embodiment, the dielectric barrier etching process is performed by placing a substrate having a layer of dielectric barrier above a layer of copper lines in a vacuum chamber. Then, a fluorine-containing process gas is introduced into the vacuum chamber. A plasma of the fluorine-containing process gas is maintained in the vacuum chamber to etch the dielectric barrier layer thereby uncovering an upper surface of the layer of copper lines. Thereafter, the uncovered surface of the layer of copper lines is treated by introducing a gas mixture including the hydrogen-containing gas and, optionally, the oxygen-containing gas or the nitrogen-containing gas into the vacuum chamber, and maintaining a plasma of the gas mixture in the vacuum chamber to remove residues formed on the surface of the layer of copper lines which were formed thereon during the dielectric barrier etching process. The temperature of the substrate is maintained between about 10 to about 90 degrees Celsius. A clean etching chemistry for the dielectric etching process is also provided, which includes the use of a fluorocarbon gas with relatively high fluorine to carbon ratio, a nitrogen-containing gas, and an oxygen containing gas in the fluorine-containing process gas.

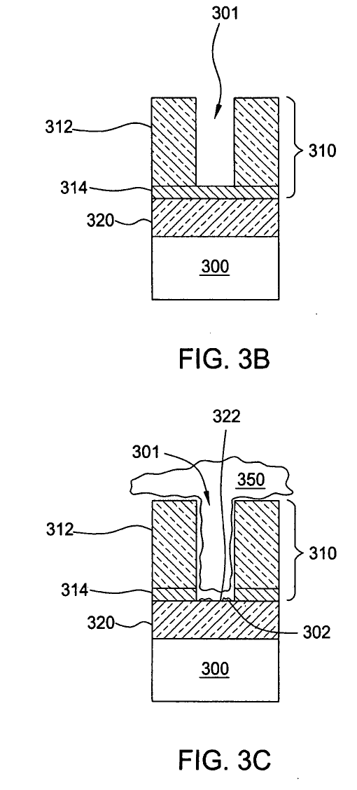

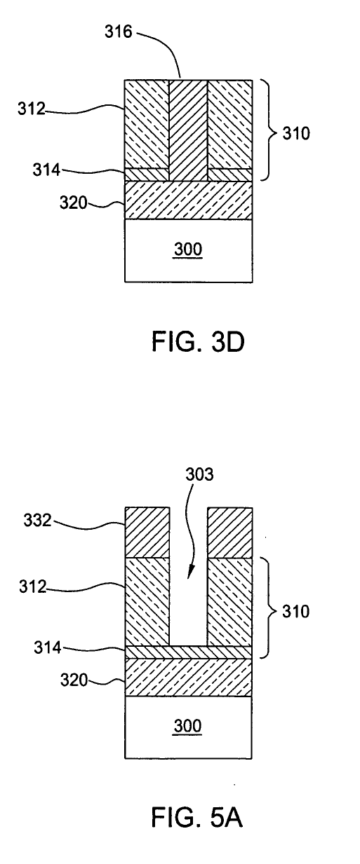

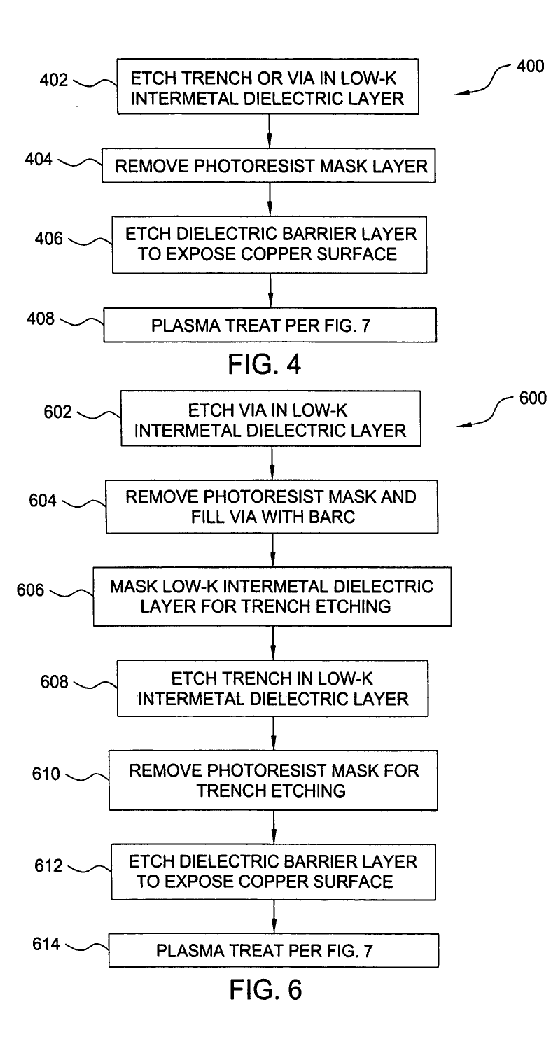

In one embodiment of the present invention, the plasma treatment process is performed after opening a barrier layer during the creation of damascene or dual damascene structures on a semiconductor substrate. FIG. 4 illustrates, in combination with FIGS. 3A-3D, an exemplary process flow 400 for creating a damascene structure in a dielectric stack 310 above a layer of copper lines 320 on a substrate 300. The dielectric stack 310 includes a low-k dielectric layer 312 over a dielectric barrier layer 314. In one embodiment, the barrier layer 314 may be formed from a low-k dielectric material, such as the BLOk™ barrier layer material available from Applied Materials, Inc., of Santa Clara, Calif.

Process flow 400, as shown in FIG. 4, includes step 402 in which at least one of a trench or via 301 is etched in the dielectric stack 310. The trench or via 301 is etched in the low-k dielectric layer 312 using a patterned photoresist layer 330 as a mask. The barrier layer 314 may be used as an etch stop layer, as shown in FIG. 3A. Process flow 400 further includes step 404 in which the photoresist layer 330 is removed, as shown in FIG. 3B, and step 406 in which the barrier layer 314 is etched to expose a surface 322 of the copper lines 320 at the bottom of the trench or via 301, as shown in FIG. 3C. The barrier layer 314 is typically plasma etched using a fluorine-based plasma 350. However, the plasma 350 undesirably creates a residue 302 of fluorine-based polymers on the surface of the exposed copper lines 320.

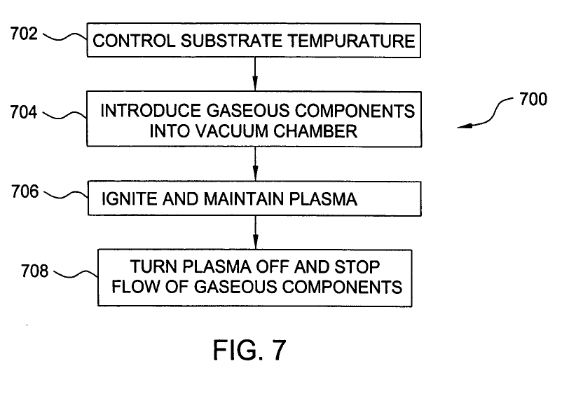

At this point, in step 408, a plasma treatment may be performed as described with reference to FIG. 7, below, to remove the residue 302 from the copper lines 320. The damascene structure may be completed by a copper fill step, as shown in FIG. 3D, in which copper 316 is deposited into and fills the trench or via 301 over the exposed surface 322 of the copper lines 320. Alternatively, other structures may be formed on the substrate 300, such as is depicted in the dual-damascene process flow described below with respect to FIG. 6.

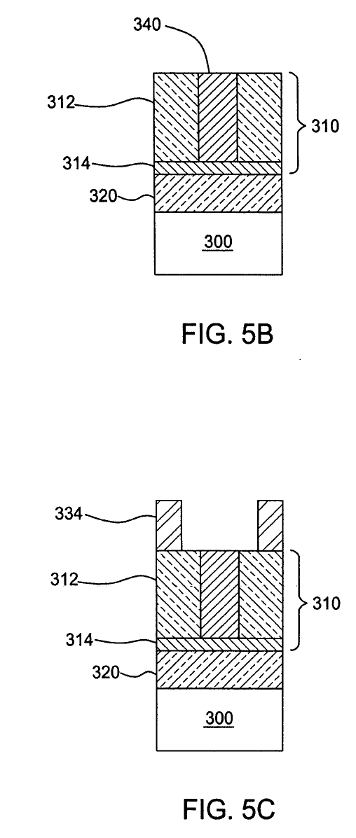

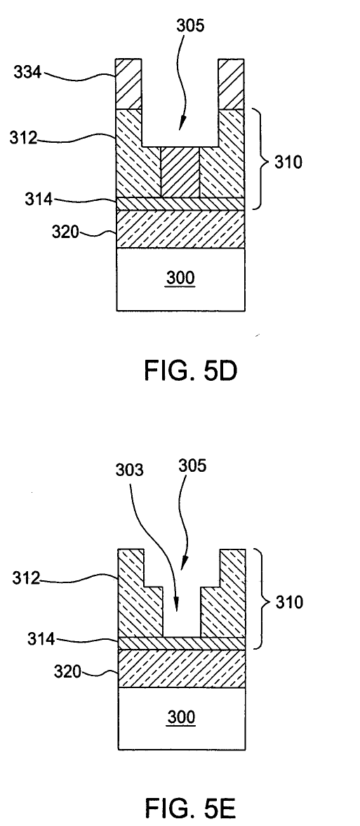

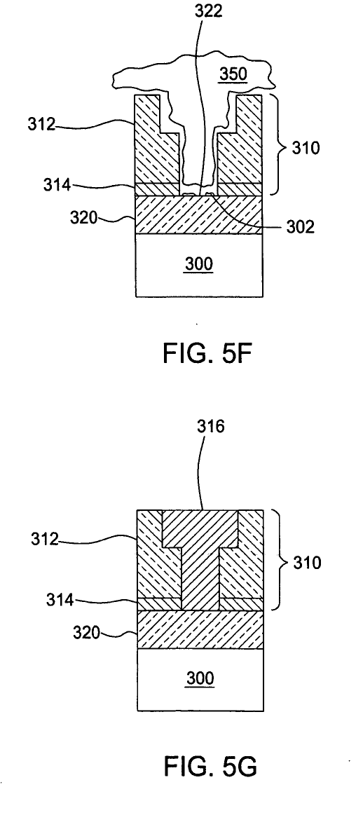

FIG. 6 illustrates, in combination with FIGS. 5A-5E, an exemplary process flow 600 for creating a dual-damascene structure in a dielectric stack 310 above a layer of copper lines 320. The dielectric stack 310 includes a low-k dielectric layer 312 over a dielectric barrier layer 314. As in the above process flow 400, the barrier layer 314 in the process flow 600 may be formed from a low-k dielectric material, such as the BLOk™ barrier layer material.

Process flow 600 includes step 602 for etching a via 303 in the low-k dielectric layer 312 using a patterned photoresist layer 332 as a mask, and optionally using the barrier layer 314 as an etch stop layer (FIG. 5A). The photoresist layer 332 is removed and the via 303 is filled with a BARC (bottom anti-reflective coating) material 340 (FIG. 5B) in step 604. In step 606, the dielectric stack 310 is masked with another photoresist mask 334 for forming trenches (FIG. 5C). In step 608 a trench 305 is etched in the low-k dielectric layer 312 (FIG. 5D). The photoresist mask 334 and the BARC material 340 is removed in step 610 (FIG. 5E). In step 612 the barrier layer 314 is etched to expose a surface 322 of the copper lines 320 at the bottom of the via 303 (FIG. 5F). The barrier layer 314 is typically plasma etched using a fluorine-based plasma 350. However, the plasma 350 undesirably creates a residue 302 of fluorine-based polymers on the surface of the exposed copper lines 320.

At this point, in step 614, a plasma treatment may be performed as described with reference to FIG. 7, below, to remove the residue 302 from the copper lines 320. The dual-damascene structure is generally completed by a copper fill step, as shown in FIG. 5G, in which copper 316 is deposited into and fills the trench 305 and the via 303 over the exposed surface 322 of the copper lines 320.

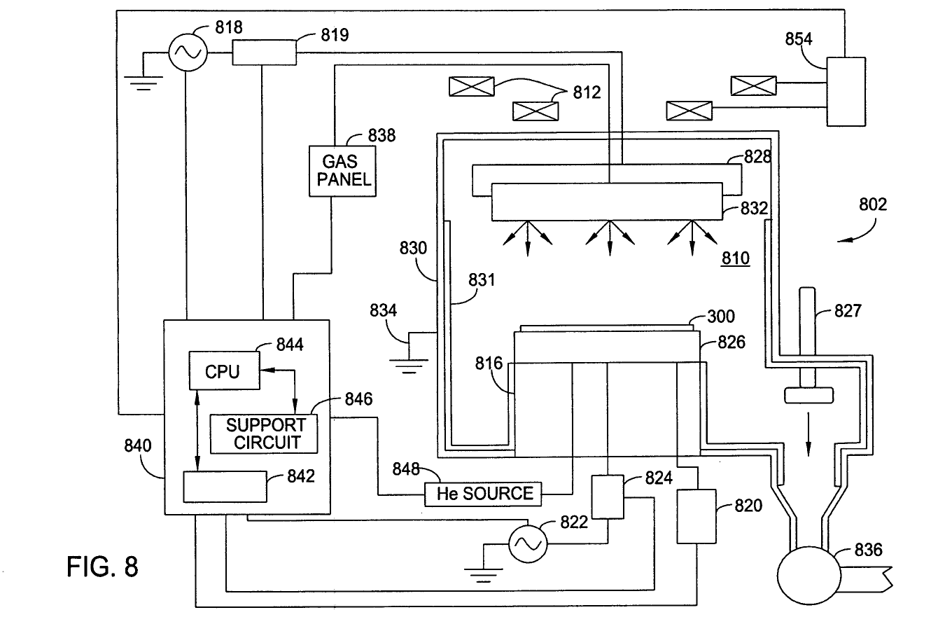

FIG. 7 illustrates one embodiment of a method 700 for performing a plasma treatment process in a plasma reactor as described below with respect to FIG. 8. As shown in FIG. 7, the method 700 begins with step 702 in which the temperature of the substrate is controlled and maintained in a range between about 10 and about 90 degrees Celsius. At step 704, gaseous components in the process gas for residue removal are introduced into a vacuum chamber of the plasma reactor using a gas distribution mechanism. Next, in step 706, one or more power sources are turned on to allow power to be coupled into the vacuum chamber to ignite the process gas into a plasma. The plasma is maintained by the one or more power sources for a time period believed to be sufficient to remove the residues on the copper surface and via sidewalls. Then at step 708, the one or more power sources are turned off and the flows of the gaseous components are terminated.

In one embodiment, the process gas used in the plasma treatment process includes a hydrogen-containing gas, such as H₂, or NH₃ or vaporized H₂O. Optionally, the process gas may also include an oxygen-containing gas, such as O₂, or vaporized H₂O. The process gas may also optionally include a nitrogen-containing gas, such as N₂ or NH₃. It is contemplated that the hydrogen-containing gas may be the same gas as the oxygen- and/or nitrogen-containing gas, such as where the hydrogen-containing gas is NH₃ or vaporized H₂O.

While not wishing to be bound by theory, it is believed that the hydrogen-containing gas, after being energized in the plasma, provides free hydrogen-containing radicals that participate in reduction reactions with the fluorine-containing residues on the copper surface and on the via sidewalls to form hydrogen fluoride and other volatile products. The oxygen-containing gas, after being energized in the plasma, provides free oxygen-containing radicals that oxidizes fluorine-containing organic polymers deposited during the dielectric barrier etching step 406 or 612. The oxygen-containing gas also helps to passivate the copper surface by forming a film of copper oxide or copper dioxide, which helps to block further reactions of the fluorine-containing residues with the copper surface. The oxygen-containing radicals and the hydrogen-containing radicals may also react together with the fluorine-containing residues to form oxygen difluoride and hydrogen oxyfluoride and other volatile products. The nitrogen-containing gas similarly helps to passivate the copper surface and cleans up fluorine-containing residues.

The plasma treatment process as described above can be performed to remove residues on a copper surface and/or via sidewalls after any barrier etching process. For optimal results, the plasma treatment process is performed after the barrier etching step 406 or 612 using a clean chemistry that results in the deposition of a relatively small amount of polymer or etch products on the copper surface. In one embodiment of the present invention, the barrier etching step 406 or 612 is performed by exposing the substrate 300 as shown in FIG. 3B or 5E to a plasma of a fluorine-containing process gas. The fluorine-containing process gas includes one or more fluorocarbon gases with relatively high fluorine to carbon ratios to provide a clean chemistry with less polymer and/or etch product depositions. The clean chemistry in the barrier-open step 406 or 612 makes it easier to remove the residues later in the plasma treatment process. Examples of fluorocarbon gases include CF₄, C₂F₆, C₄F₆, C₄F₈, CHF₃, CH₂F₂, CH₃F, and the like, of which CF₄ is more often used. The fluorine-containing process gas in the barrier etching step 406 or 612 may optionally include a nitrogen-containing gas, such as N₂, N₂O, and the like, of which N₂ is more often used, and/or an oxygen-containing gas, such as O₂. The oxygen-containing gas and/or the nitrogen-containing gas each help to enhance the cleanliness of material surfaces on the substrate 300 by contributing oxygen-containing and/or nitrogen-containing reactive species in the plasma, which can react with some of the polymer and/or etch product deposits to form volatile species, such as CN in the case of a nitrogen-containing gas.

In one embodiment, the plasma treatment process is performed in the same plasma reactor that is used to perform the barrier etching step 406 or 612 so that transfer of the substrate from one plasma reactor to another is not necessary. Alternatively, the barrier etching step 406 or 612 and the plasma treatment process may be performed consecutively in two separate plasma reactors.

FIG. 8 depicts a schematic, cross-sectional diagram of a dual frequency capacitive plasma source etch reactor 802 suitable for performing the present invention. This reactor is described in depth in commonly owned U.S. patent application Ser. No. 10/192,271, filed Jul. 9, 2002, which is herein incorporated by reference. One such etch reactor suitable for performing the invention is the ENABLER™ processing chamber, available from Applied Materials, Inc., of Santa Clara, Calif.

As shown in FIG. 8, a reactor 802 includes a process chamber 810 having a conductive chamber wall 830. The chamber wall 830 is connected to an electrical ground 834 and comprises a ceramic liner 831. The ceramic liner 831 facilitates in situ self-cleaning capabilities of the chamber 810, so that byproducts and residues deposited on the ceramic liner 831 can be readily removed from the liner 831 after each substrate has been processed. The process chamber 810 also includes a support pedestal 816 and an upper electrode 828 spaced apart from and opposed to the support pedestal 816. The support pedestal 816 includes an electrostatic chuck 826 for retaining the substrate 300. The electrostatic chuck 826 is controlled by a DC power supply 820. A showerhead 832 is mounted to the upper electrode 828 and is coupled to a gas panel 838 for controlling introduction of various gases into the chamber 810. The showerhead 832 may include different zones such that various gases can be released into the chamber 810 with different volumetric flow rates.

The support pedestal 816 is coupled to a radio frequency (RF) bias power source 822 through a matching network 824. The bias power source 822 is generally capable of producing an RF signal having a tunable frequency of from about 50 kHz to about 53.56 MHz and a bias power of about 0 to 5,000 Watts. Optionally, the bias power source 822 may be a DC or pulsed DC source. The upper electrode 828 is coupled to an RF source power 818 through an impedance transformer 819 (e.g., a quarter wavelength matching stub). The RF source power 818 is generally capable of producing an RF signal having a tunable frequency of about 160 MHz and a source power of about 0 to 5,000 Watts. The chamber 810 is a high vacuum vessel that is coupled through a throttle valve 827 to a vacuum pump 836.

The reactor 802 may also include one or more coil segments or magnets 812 positioned exterior to the chamber wall 830, near a chamber lid 513. The coil segment(s) 812 are controlled by a DC power source or a low-frequency AC power source 854.

During processing of the substrate 300, gas pressure within the interior of the chamber 810 is controlled using the gas panel 838 and the throttle valve 827, and maintained in a range of about 0.1 to 999 mTorr. The temperature of the chamber wall 830 is controlled using liquid-containing conduits (not shown) that are located in and/or around the wall. The temperature of the substrate 300 is controlled by regulating the temperature of the support pedestal 816 via a cooling plate (not shown) having channels formed therein for flowing a coolant. In addition, a backside gas, such as a helium (He) gas from a Helium source 848, is provided into channels disposed between the back side of the substrate 300 and grooves (not shown) formed in the surface of the electrostatic chuck 826. The electrostatic chuck 826 may also include a resistive heater (not shown) within the chuck body to heat the chuck 826 to a steady-state temperature during processing. The backside He gas is used to facilitate uniform heating of the substrate 300. The substrate 300 can be maintained at a temperature of between about 10 to about 500 degrees Celsius.

A controller 840 including a central processing unit (CPU) 844, a memory 842, and support circuits 846 for the CPU 844 is coupled to the various components of the reactor 802 to facilitate control of the processes of the present invention. The memory 842 can be any computer-readable medium, such as random access memory (RAM), read only memory (ROM), floppy disk, hard disk, or any other form of digital storage, local or remote to the reactor 802 or CPU 844. The support circuits 836 are coupled to the CPU 844 for supporting the CPU in a conventional manner. These circuits include cache, power supplies, clock circuits, input/output circuitry and subsystems, and the like. A software routine or a series of program instructions stored in the memory 842, when executed by the CPU 844, causes the reactor 802 to perform processes of the present invention.

FIG. 8 only shows one exemplary configuration of various types of plasma reactors that can be used to practice the invention. For example, different types of source power and bias power can be coupled into the plasma chamber using different coupling mechanisms. Using both the source power and the bias power allows independent control of a plasma density and a bias voltage of the substrate with respect to the plasma. In some applications, the source power may not be needed and the plasma is maintained solely by the bias power. The plasma density can be enhanced by a magnetic field applied to the vacuum chamber using electromagnets driven with a low frequency (e.g., 0.1-0.5 Hertz) AC current source or a DC source. In other applications, the plasma may be generated in a different chamber from the one in which the substrate is located, and the plasma subsequently guided toward the substrate using techniques known in the art.

### EXAMPLE

To illustrate applications of the present invention, the substrate 300 with layers of materials formed thereon as shown in FIG. 3B or 5E is prepared according to the process flow described in steps 402 through 404, shown in FIG. 4, or steps 602 through 610, shown in FIG. 6. In one embodiment, the substrate 300 may be a silicon substrate of 200 mm (8 inch) or 300 mm (12 inch) diameter. The low-k dielectric layer 312 may have a thickness of about 0.4-1.5 microns. The barrier layer 314 may have a thickness of about a few hundred angstroms. One example of a material suitable for use as the low-k dielectric layer 312 in FIG. 3B or 5E is Black Diamond™ film, commercially available from Applied Materials, Inc., of Santa Clara, Calif. One example of a material suitable for use as the low-k dielectric barrier layer 314 is BLOk™ (barrier low-k) film, also available from Applied Materials. BLOk™ film is a silicon carbide based film formed using the chemical vapor deposition (CVD) or plasma enhanced CVD (PECVD) processes described in commonly owned U.S. Pat. No. 6,287,990 B1, issued Sep. 11, 2001, and U.S. Pat. No. 6,303,523 B2, issued Oct. 16, 2001, both of which are incorporated herein by reference.

The substrate 300, with the layers of materials formed thereon as shown in FIG. 3B or 5E, is processed in the reactor 802 according to steps 406 or 612, respectively shown in FIGS. 4 and 5, in which the barrier layer 314 is etched until the copper surface 322 at the bottom of the trench or via 301, 303 is exposed, as shown in FIG. 3C or 5F.

The substrate 300 is next processed according to process flow 700, depicted in FIG. 7, in which a plasma treatment process is performed to remove residues on the copper surface 322 and sidewalls of the via 301 or 303. The process flow 700 includes step 702, in which the substrate temperature is controlled at a predetermined value. In one embodiment, the substrate temperature is controlled to be between about 10 to about 90 degrees Celsius. In another embodiment, the temperature of the substrate is controlled to be between about 50 and about 80 degrees Celsius.

In one embodiment, the substrate temperature may be controlled by controlling the temperature of the pedestal 816. In one embodiment, the temperature of the pedestal 816 is controlled to be between about −20 and about 40 degrees Celsius. Alternatively or in addition, the substrate temperature may be controlled by controlling and the flow of the gas from the He source 848. In one embodiment, the pressure of the backside He gas at the interface between the substrate 300 and the pedestal 816 is maintained at less than 10 Torr, for example, in the range of from about 0.1 to about 9.9 Torr. In one embodiment, the backside He gas pressure is about 1 Torr.

The process flow 700 further includes step 704, in which gaseous components are supplied to the process chamber 810 through the showerhead 832 to form a gas mixture therein. The flow rates of each gaseous component may be controlled in a range of from about 0 to about 7500 sccm. The pressure of the gas mixture in the process chamber 810 is adjusted by regulating at least one process parameter such as the volumetric flow rate of one or more gaseous components in the gas mixture, or a position of the throttle valve 827. When the dielectric barrier layer 314 is opened in either step 406 or 612, the gas mixture includes one or more fluorocarbon gas and, optionally, one or more other gases, as discussed above. When the process flow 700 is used to perform the plasma treatment process, the gas mixture includes a hydrogen-containing gas and may optionally include an oxygen-containing gas or a nitrogen-containing gas.

Next, in step 706, the plasma of the gas mixture is ignited and maintained by turning on the RF source power 818. Thereafter, or about simultaneously, the RF bias power 822 is turned on to electrically bias the substrate support pedestal 816. Thus, the substrate 300 on the pedestal 816 is exposed to the plasma of the gas mixture. Alternatively, the plasma of the gas mixture may be ignited and maintained solely by the RF bias power 822.

During the etch steps 406, 612 to open the dielectric barrier layer 314, the plasma is maintained for a predetermined time period based on the thickness of the dielectric barrier layer 314 or is terminated using a conventional optical endpoint measurement technique that determines, by monitoring emissions from the plasma or other endpoint technique, whether the dielectric barrier material in the trenches or vias 301, 303 is removed. During the plasma treatment process, in step 706, the plasma is continued for a predetermined period of time (plasma time). Thereafter, at step 708, the plasma is extinguished by turning off the RF source power 818 and the bias source 822—or just the bias source 822 in embodiments where the RF source power 818 is not used—and the flow of the gaseous components is stopped.

The foregoing steps of the described process flows need not be performed sequentially, e.g., some or all of the steps may be performed simultaneously or in different order. In one embodiment, the process flows are performed by the controller 840 as shown in FIG. 8, according to program instructions stored in memory 842. Alternatively, some or all of the steps in the described process flows may be performed in hardware such as an application-specific integrated circuit (ASIC) or other type of hardware implementation, or a combination of software or hardware.

Table I summarizes the ranges, i.e., minimum and maximum values, and exemplary values of a few process parameters used to perform the barrier-open steps 406, 612 using the reactor 500 shown in FIG. 5.

TABLE I

| Process Parameters | | Minimum | Maximum | Example |
|---|---|---|---|---|
| Process Gas (sccm) | CF₄ | 2 | 200 | 30 |
| | N₂ | 0 | 400 | 90 |
| | O₂ | 0 | 400 | 10 |

| | | | |
|---|---|---|---|
| Upper Electrode Power (W) | 0 | 1000 | 200 |
| Bias Power (W) | 50 | 2500 | 300 |
| Gas Pressure (mTorr) | 5 | 500 | 30 |
| Substrate Pedestal Temperature (° C.) | −20 | 40 | 20 |

In one embodiment, the hydrogen-containing gas of the plasma treatment step is NH₃. In embodiments where the process gas includes O₂ as the optional oxygen-containing gas, the process gas is introduced into the vacuum chamber such that a volumetric flow ratio of O₂:NH₃ is in the range of 1:1 to about 100:1, and in one embodiment, in the range of about 3:1 to about 10:1. The plasma of the process gas is maintained by a source power for controlling a density of the plasma. A bias power is optionally used for controlling an electric bias voltage between the plasma and the substrate. A ratio of the source power to the bias power is about 1:1 to about 5:1. Alternatively, the plasma of the process gas may be maintained solely by the bias power.

Table II summarizes the ranges and exemplary values of the process parameters used to perform the plasma treatment process 700 using NH₃ and, optionally, O₂.

TABLE II

| Process Parameters | | Minimum | Maximum | Example |
|---|---|---|---|---|
| Process Gas (sccm) | O₂ | 0 | 1000 | 500 |
| | NH₃ | 20 | 1000 | 100 |

| | | | |
|---|---|---|---|
| Upper Electrode Power (W) | 0 | 3000 | 2000 |
| Bias Power (W) | 0 | 1000 | 400 |
| Gas Pressure (mTorr) | 5 | 500 | 30 |
| Substrate Pedestal Temperature (° C.) | −20 | 40 | 20 |
| Plasma Time (seconds) | As | As | 30 |
| | necessary | necessary | |

In another embodiment, the hydrogen-containing gas of the plasma treatment step is H₂ and the oxygen-containing gas is vaporized H₂O. The process gas is introduced into the vacuum chamber such that a volumetric flow ratio of H₂O:H₂ is in the range of 1:10 to about 1:1000, and in one embodiment, about 1:100.

Table III summarizes the ranges and exemplary values of the process parameters used to perform another embodiment of the plasma treatment process 700 using only H₂.

TABLE III

| Process Parameters | | Minimum | Maximum | Example |
|---|---|---|---|---|
| Process Gas (sccm) | H₂ | 20 | 1000 | 350 |

| | | | |
|---|---|---|---|
| Upper Electrode Power (W) | 0 | 3000 | 2000 |
| Bias Power (W) | 0 | 1000 | 100 |
| Gas Pressure (mTorr) | 5 | 1000 | 20 |
| Substrate Pedestal | −20 | 40 | 20 |
| Temperature (° C.) | | | |
| Plasma Time (seconds) | As necessary | As necessary | 30 |

The plasma treatment process may be run for a period of time sufficient to remove the residues present on the copper surface and via sidewalls. In one embodiment of the present invention, the plasma time is about 15 to about 50 seconds. It is contemplated that longer, or shorter, plasma treatment times may be used in situations where there is more, or less, residue present on the exposed copper surfaces and via sidewalls.

Thus, with just about 30 seconds of plasma treatment, the plasma treatment process flow 700 can remove most or all of the residue on the copper surface 322 and sidewalls of the via 301 or 303 after the barrier-open step 406, 612. Compared with the prior art method of wet clean for residue removal, which typically includes about 5-10 minutes of wet solution time, 3-5 minutes of rinse time, 20 minutes of spin drying time, and substrate transfers from the plasma reactor to a wet bench and between different parts of the wet bench, great advantage can be gained by performing the plasma treatment process flow 700 after the barrier-open step 406, 612.

Although the plasma treatment process flow 700 has been described to follow the barrier-open step 406, 612, in practice, the plasma treatment process can be used to remove fluorine-containing residues on copper surface resulting from other processes, such as processes for opening barrier layer having different material content from that of the BLOk films and using different processing technology from those described herein. In fact, the plasma treatment process can be used to remove fluorine-containing residues on copper or other material surfaces resulting from their exposure to any fluorine-containing processing environment.

Although the invention has been described above with reference to a few specific embodiments, the description is illustrative and is not to be construed as limiting the invention. Various modifications may occur to those skilled in the art without departing from the true spirit and scope of the invention, as defined by the appended claims.

What is claimed is:

1. A method of removing residue from a layer of conductive material on a substrate, comprising:
introducing a process gas into a vacuum chamber having a substrate with residue formed on an exposed surface due to processing in a fluorine-containing environment, the process gas including a hydrogen-containing gas;
forming and maintaining a plasma of the process gas in the vacuum chamber for a predetermined period of time to remove the residue from the surface; and
maintaining the temperature of the substrate between about 10 degrees Celsius and about 90 degrees Celsius during the plasma forming and maintaining step.

2. The method of claim 1, wherein the process gas further comprises an oxygen-containing gas.

3. The method of claim 2, wherein the oxygen-containing gas is O₂ and the hydrogen-containing gas is NH₃, and wherein the process gas is introduced into the vacuum chamber such that a volumetric flow ratio of O₂:NH₃ is in the range of from about 1:1 to about 100:1.

4. The method of claim 3, wherein the volumetric flow ratio of NH₃:O₂ is from about 3:1 to about 10:1.

5. The method of claim 1, wherein the plasma of the process gas is maintained for about 15 to about 50 seconds.

6. The method of claim 1, wherein the step of forming and maintaining a plasma further comprises:
providing the vacuum chamber with power from a first power supply.

7. The method of claim 6, wherein the step of forming and maintaining a plasma further comprises:
providing the vacuum chamber with power from a second power supply, wherein the first power supply controls a density of the plasma and the second power supply controls an electric bias voltage between the plasma and the substrate.

8. The method of claim 7, wherein a ratio of the first power supply to the second power supply is about 1:1 to about 5:1.

9. The method of claim 1, wherein the process gas further comprises a nitrogen-containing gas.

10. The method of claim 1, wherein the step of maintaining the temperature of the substrate further comprises:
maintaining the temperature of the substrate between about 50 degrees Celsius and about 80 degrees Celsius.

11. A method of opening a dielectric barrier layer above a layer of copper lines on a semiconductor substrate during a damascene or dual damascene process, comprising:
introducing a fluorine-containing process gas into a vacuum chamber in which the substrate is located;
maintaining a plasma of the fluorine-containing process gas in the vacuum chamber to etch the dielectric barrier layer, thereby uncovering an upper surface of the layer of copper lines;
introducing a process gas including a hydrogen-containing gas into the vacuum chamber;
forming and maintaining a plasma of the process gas in the vacuum chamber to remove fluorine-containing residue formed on the substrate; and
maintaining the temperature of the substrate between about 10 degrees Celsius and about 90 degrees Celsius during the plasma forming and maintaining step.

12. The method of claim 11, wherein the fluorine-containing gas includes at least one of CF₄, C₂F₆, C₄F₆, C₄F₈, CHF₃, CH₂F₂, and CH₃F.

13. The method of claim 11, wherein the fluorine-containing gas includes CF₄.

14. The method of claim 11, wherein the fluorine-containing gas further includes a nitrogen-containing gas and an oxygen-containing gas.

15. The method of claim 11, wherein the hydrogen-containing gas is NH₃.

16. The method of claim 11, wherein the process gas further comprises an oxygen-containing gas.

17. The method of claim 16, wherein the oxygen containing gas is O₂ and the hydrogen-containing gas is NH₃.

18. The method of claim 16, wherein the process gas is introduced into the vacuum chamber such that a ratio of a volumetric flow rate of the oxygen-containing gas to that of the hydrogen-containing gas is in the range of 1:1 to about 100:1.

19. The method of claim 18, wherein the ratio of the volumetric flow rate of the oxygen-containing gas to that of the hydrogen-containing gas is in the range of 3:1 to about 10:1.

20. The method of claim 11, wherein the step of forming and maintaining a plasma further comprises:
providing the vacuum chamber with power from a first power supply.

21. The method of claim 20, wherein the step of forming and maintaining a plasma further comprises:
providing the vacuum chamber with power from a second power supply, wherein the first power supply controls a density of the plasma and the second power supply controls an electric bias voltage between the plasma and the substrate.

22. The method of claim 21, wherein a ratio of the first power supply to the second power supply is about 1:1 to about 5:1.

23. The method of claim 11, wherein the plasma of the process gas is maintained for about 15 to about 50 seconds.

24. The method of claim 11, further comprising:
forming a layer of copper on top of the upper surface of the layer of copper lines after the residues have been removed by the plasma.

25. The method of claim 11, wherein the process gas further comprises a nitrogen-containing gas.

26. The method of claim 11, wherein the step of maintaining the temperature of the substrate further comprises:
maintaining the temperature of the substrate between about 50 degrees Celsius and about 80 degrees Celsius.

27. A computer readable medium storing therein program instructions that when executed by a computer cause a plasma reactor to open a dielectric barrier layer above a layer of copper lines on a semiconductor substrate during a damascene or dual damascene process, the program instructions comprising:
instructions for introducing a fluorine-containing process gas into a vacuum chamber of the plasma reactor in which the substrate is located;
instructions for maintaining a plasma of the fluorine-containing process gas in the vacuum chamber to etch the dielectric barrier layer thereby uncovering a surface of the layer of copper lines;
instructions for introducing a process gas including a hydrogen-containing gas into the vacuum chamber;
instructions for forming and maintaining a plasma of the process gas in the vacuum chamber to remove residues formed on the surface of the layer of copper lines; and
instructions for maintaining the temperature of the substrate between about 10 degrees Celsius and about 90 degrees Celsius during the plasma forming and maintaining step.

28. The computer readable medium of claim 27, wherein the instructions for introducing the process gas further comprises:
instructions for introducing an oxygen-containing gas; and
instructions for introducing the oxygen-containing gas with a first volumetric flow rate and instructions for introducing the hydrogen-containing gas with a second volumetric flow rate, and wherein a ratio of the first volumetric flow rate to the second volumetric flow rate is about 1:1 to about 100:1.

29. The computer readable medium of claim 27, wherein the instructions for maintaining the plasma further comprises:
instructions for turning on a first power supply coupled to the vacuum chamber.

30. The computer readable medium of claim 29, wherein the instructions for maintaining the plasma further comprises:
instructions for turning a second power supply coupled to the vacuum chamber such that a ratio of the first power supply to the second power supply is in the range of about 1:1 to about 5:1, wherein the first power supply controls a density of the plasma and the second power supply controls an electric bias voltage between the plasma and the substrate.

31. The computer readable medium of claim 27, wherein instructions for maintaining the temperature of the substrate further comprises:
instructions for maintaining the temperature of the substrate between about 50 degrees Celsius and about 80 degrees Celsius.
